(19) United States
(12) Patent Application Publication
(10) Pub. No.: US 2007/0221756 A1
(43) Pub. Date: Sep. 27, 2007

(54) Lawn sprinkler with changeable nozzles

(76) Inventors: Po-Hsiung Wang, Miao-Li Hsien (TW); Tzu-Meng Wang, Miao-Li Hsien (TW)

Correspondence Address: HERSHKOVITZ & ASSOCIATES, 2845 DUKE STREET, ALEXANDRIA, VA, 22314, US

(21) Appl. No.: 11/389,298

(22) Filed: Mar. 27, 2006

(51) Int. Cl. A62C 31/02; B05B 1/32; B05B 1/00

(52) U.S. Cl. 239/390; 239/451; 239/600

(57) ABSTRACT

A lawn sprinkler with changeable nozzles has a main bracket, a rotating device, a connecting device and a nozzle tube. The rotating device is mounted in the main bracket and connects to a water pipe providing waters. The connecting device is attached to the rotating device and has a water outlet. The nozzle tube is mounted pivotally on the connecting device and has multiple water inlets, multiple nozzle assemblies and at least one board. The water inlets selectively align with the water outlet of the connecting device. One nozzle assembly corresponds to one water inlet. Each board is formed between each two water inlets to distinguish the water. The nozzle tube is rotated relative to the connecting device to change the water inlet of the nozzle tube aligning with the water outlet of the connecting device.

### BACKGROUND OF THE INVENTION

1. Field of the Invention

The present invention relates to a lawn sprinkler, especially to a lawn sprinkler that has changeable nozzles.

2. Description of the Prior Arts

To conveniently water lawns and the like, sprinklers are mounted on the ground to spray water on the lawn automatically around the sprinkler. A conventional sprinkler has a nozzle assembly. Types of water spraying from the conventional sprinkler are always changed to suit different times, seasons or plants By means of changing the nozzle assembly on the conventional sprinkler. However, the nozzle assembly of the conventional sprinkler is not changable, is difficult to change or can only be adjusted between a spray and a solid stream. Therefore, the type of spray of the conventional sprinkler cannot meet the wide range of existing requirements.

To overcome the shortcomings, the present invention provides a lawn sprinkler with changeable nozzles to mitigate or obviate the aforementioned problems.

### SUMMARY OF THE INVENTION

The main objective of the present invention is to provide a lawn sprinkler with changeable nozzles. The lawn sprinkler with changeable nozzles has a main bracket, a rotating device, a connecting device and a nozzle tube. The rotating device is mounted in the main bracket and connects to a water pipe providing waters. The connecting device is attached to the rotating device and has a water outlet. The nozzle tube is mounted pivotally on the connecting device and has multiple water inlets, multiple nozzle assemblies and at least one board. The water inlets selectively align with the water outlet of the connecting device. One nozzle assembly corresponds to one water inlet. Each board is formed between each two water inlets to distinguish the water. The nozzle tube is rotated relative to the connecting device to change the water inlet of the nozzle tube aligning with the water outlet of the connecting device.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a lawn sprinkler with changeable nozzles in accordance with the present invention;

FIG. 2 is an exploded perspective view of the sprinkler in FIG. 1;

FIG. 3 is a partial exploded perspective view of the sprinkler in FIG. 1;

FIG. 4 is an end view of a nozzle tube of the sprinkler in FIG. 1;

FIG. 5 is an end view of a nozzle tube of another embodiment of a sprinkler in accordance with the present invention;

FIG. 6 is an end view of the nozzle tube of the sprinkler in FIG. 1;

FIG. 7 is an operational end view of the nozzle tube of the sprinkler in FIG. 1;

FIG. 8 is another operational end view of the nozzle tube of the sprinkler in FIG. 1;

FIG. 9 is a perspective view of the another embodiment of the sprinkler 1 in FIG. 5;

FIG. 10 is a partial exploded perspective view of the sprinkler in FIG. 1;

FIG. 11 is an operational perspective view of the sprinkler in FIG. 1;

FIG. 12 is a partial exploded perspective view of the sprinkler in FIG. 1; and

FIG. 13 is a partial side view in partial section of the sprinkler in FIG. 1.

### DETAILED DESCRIPTION OF THE PREFERRED EMBODIMENTS

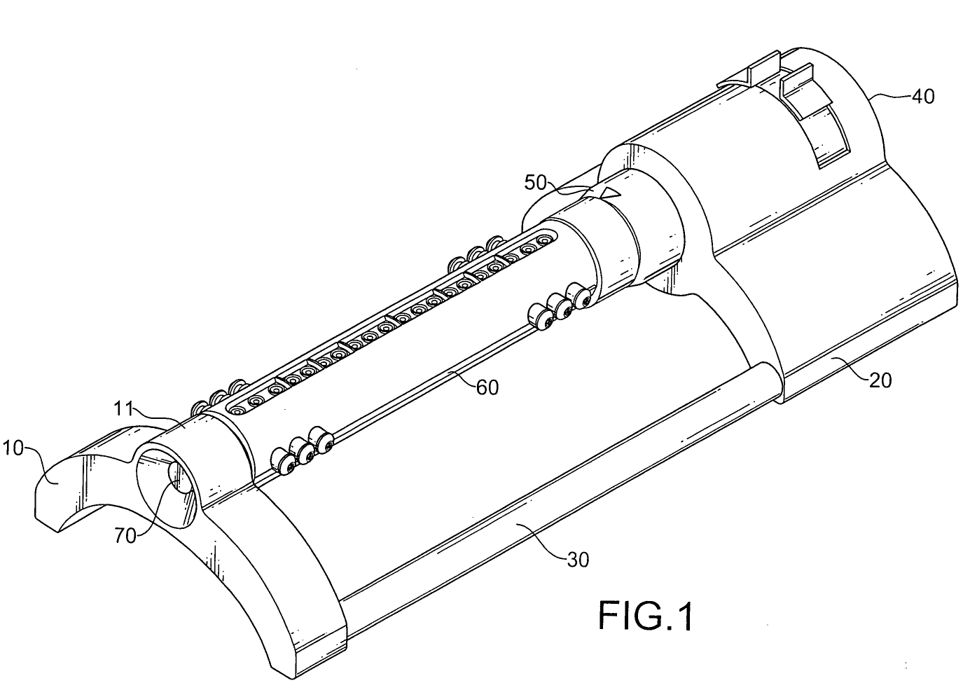

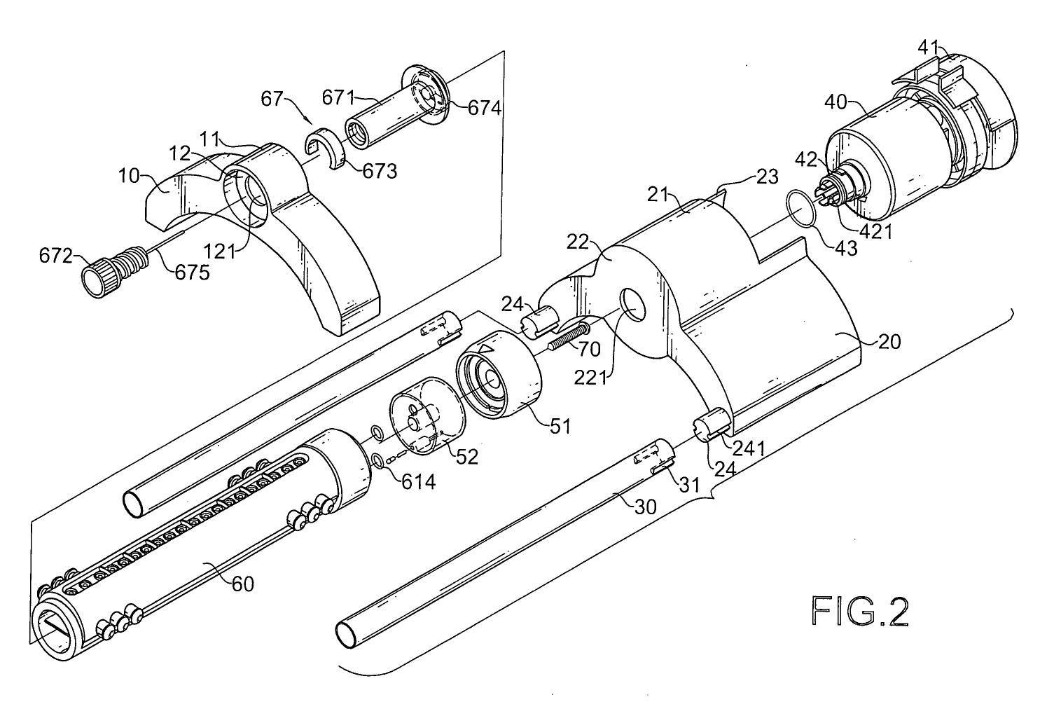

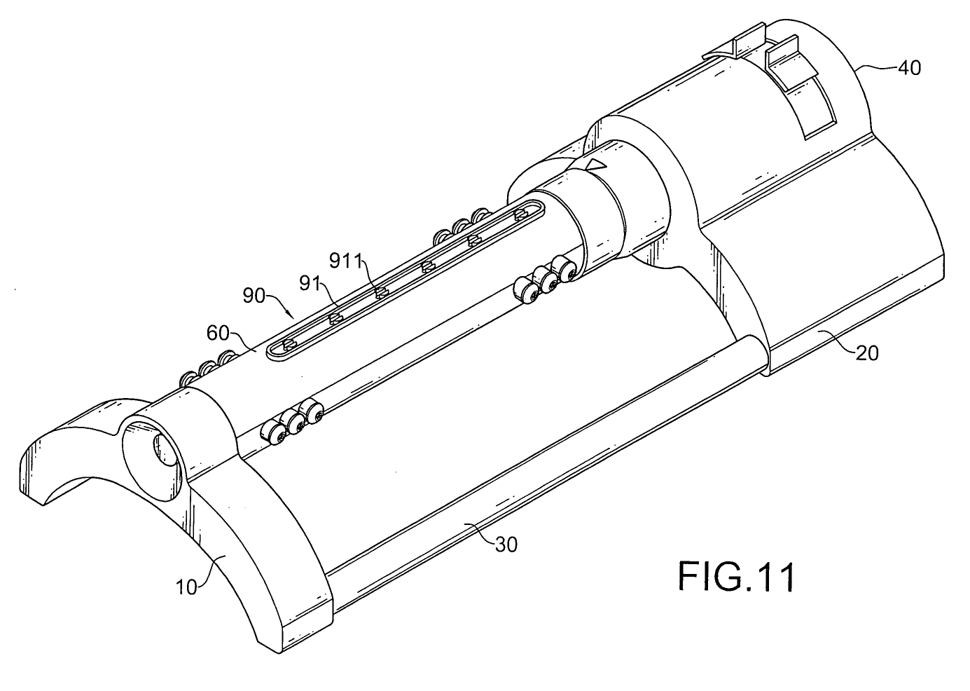

With reference to FIGS. 1, 2, 10 and 11, a lawn sprinkler with changeable nozzles in accordance with the present invention comprises a main bracket, a rotating device (40), a connecting device (50), an nozzle tube (60), an optional fastening device (70), an optional adjustable spraying assembly (80) and an optional spraying assembly (90).

The main bracket has a first bracket (10) and a second bracket (20) and may have two hollow connecting rods (30). The first bracket (10) may be arcuate and may have a bearing (11) and a partition (12). The partition (12) is formed radially in the bearing (11) and has a central hole (121). The second bracket (20) is oppositely to the first bracket (10), has an inner side and an outer side, may be arcuate and may have a bearing (21), a partition (22), a notch (23) and two pins (24). The bearing (21) has an inner end and an outer end. The partition (22) is formed on the inner end of the bearing (21) and has a central hole (221). The notch (23) is formed in the outer end of the bearing (21). The pins (24) are formed oppositely on the inner side of the second bracket (20). Each pin (24) has an outer wall and two slots (241). The slots (241) are formed longitudinally in the outer wall of the pin (24). The connecting rods (30) are mounted securely between the first and second brackets (10, 20), and each connecting rod (30) has a first end, a second end and two protrusions (31). The first ends of the connecting rods (30) are attached to the first bracket (10). The second end is an open end and is mounted around one of the pin (24) on the second bracket (20). The protrusions (31) are formed on the second end of the connecting rod (30) and engage the slots (241) of the pin (24) of the second bracket (20) to attach the connecting rod (30) to the second bracket (20).

The rotating device (40) connects to a water pipe that supplies water, is mounted in the second bracket (20) and has a transmission rod (42). The transmission rod (42) extends through the inner side of the second bracket (20), may extend through the central hole (221) of the partition (22) of the second bracket (20) and may have a distal end and multiple protrusions (421). The protrusions (421) are formed radially on the distal end of the transmission rod (42). The rotating device (40) may be mounted in the bearing (21) of the second bracket (20) and may have a mounting bracket (41) and a waterproof washer (43). The mounting bracket (41) engages the notch (23) of the second bracket (20) to mount the rotating device (40) in the second bracket (20). The waterproof washer (43) is mounted around the transmission rod (42).

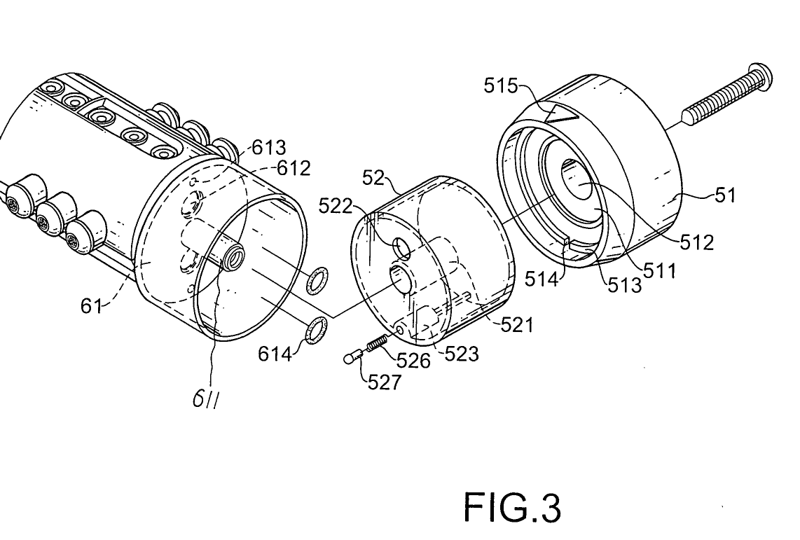

With further reference to FIG. 3, the connecting device (50) is attached to the transmission rod (42) of the rotating device (40) and has an external sleeve (51) and an internal sleeve (52).

The external sleeve (51) is attached to the transmission rod (42) of the rotating device (40) and has an inner wall, an outer wall, a first end, a second end, a partition (511), an optional annular rib (513) and an optional mark (515). The partition (511) is formed radially on the inner wall of the external sleeve (51) and has a central hole (512). The central hole (512) of the partition (511) of the external sleeve (51) is mounted securely on the transmission rod (42) and may engage the protrusions (421) on the transmission rod (42) to mount the external sleeve (51) securely on the transmission rod (42). The annular rib (513) is formed around the inner wall of the external sleeve (51) near the first end of the external sleeve (51) and has a gap (514). The mark (515) is formed on the outer wall of the external sleeve (51) at a position opposite to the gap (514) in the annular rib (513) of the external sleeve (51).

The internal sleeve (52) is mounted securely in the first side of the external sleeve (51), has an opening end, a close end and a water outlet (522) and may have a central shaft (521), a positioning rib (523), a spring (526) and a positioning pin (527). The opening end of the internal sleeve (52) communicates with the central hole (512) of the external sleeve (51). The water outlet (522) is formed through the close end of the internal sleeve (52). The central shaft (521) is hollow, is formed on the close end of the internal sleeve (52), extends to the opening end of the internal sleeve (52) and extends through the central hole (512) of the external sleeve (51). The positioning rib (523) is hollow, is formed on the close end of the internal sleeve (52), protrudes from the opening end of the internal sleeve (52) and has an opening end and a close end. The close end of the positioning rib (523) protrudes from the opening end of the internal sleeve (52) and engages the gap (514) in the annular rib (513) of the external sleeve (51) to connect the internal sleeve (52) securely to the external sleeve (51). The spring (526) is mounted in the opening end of the positioning rib (523). The positioning pin (527) is mounted in and extends out of the opening end of the positioning rib (523) and presses against the spring (526) in the positioning rib (523).

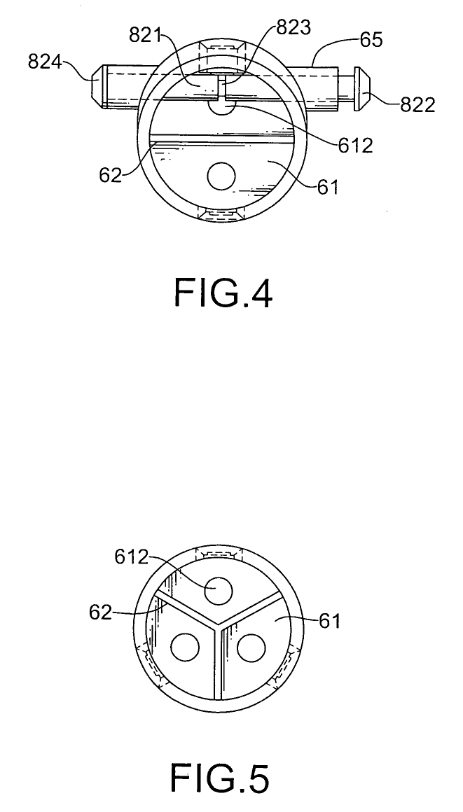

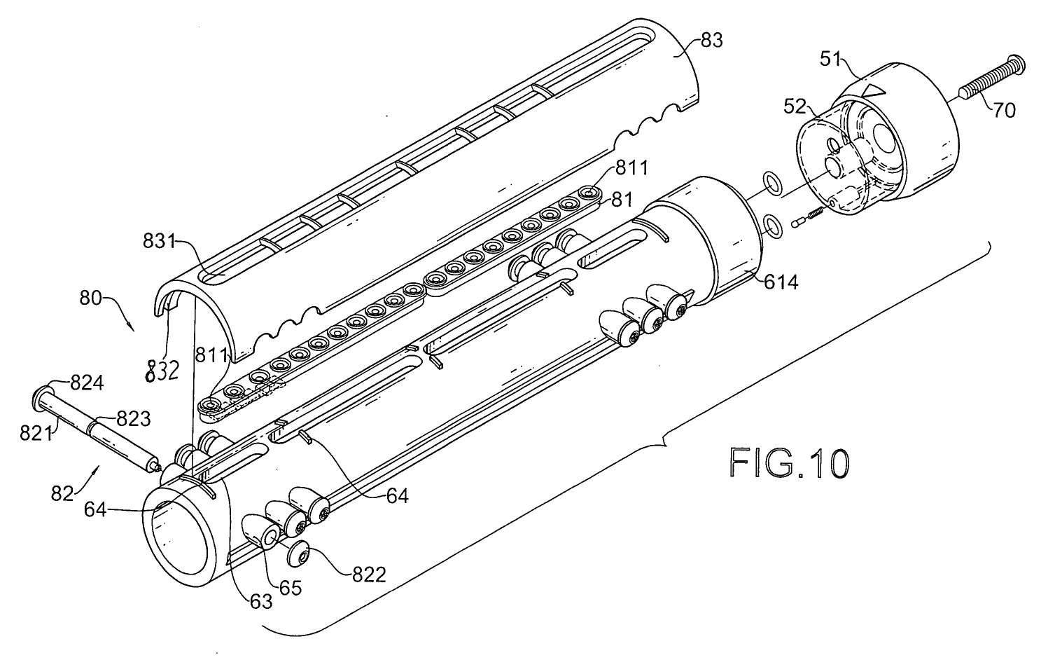

With further reference to FIGS. 4 and 5, the nozzle tube (60) is mounted in the main bracket, is mounted rotatably on the internal sleeve (52) and has an outer wall, a first end, a second end, a partition (61), an optional central rod (611), an optional screw (70), multiple optional washers (614), at least one board (62), multiple nozzle assemblies (63) and an optional fastening device (67). With further reference to FIG. 10, the nozzle tube (60) may have multiple mounting ribs (64) and multiple passing tubes (65). The partition (61) is formed on and seals the second end of the nozzle tube (60), has an inside surface, an outside surface, multiple water inlets (612) and multiple optional positioning detents (613) and may have two water inlets (612) or three water inlets (612). The outside surface of the partition (61) of the nozzle tube (60) abuts the close end of the internal sleeve (52). The water inlets (612) are formed separately through the partition (61) of the nozzle tube (60) and selectively align with the water outlet (522) of the internal sleeve (52). The positioning detents (613) are formed in the outside surface of the partition (61) of the nozzle tube (60), respectively correspond to the water inlets (612) of the partition (61) of the nozzle tube (60) and selectively engage the positioning pin (527) of the internal sleeve (52) to selectively position the nozzle tube (60) relative to the internal sleeve (52). The central rod (611) of the nozzle tube (60) is formed on the outside surface of the partition (61) of the nozzle tube (60), extends through the central shaft (521) of the internal sleeve (52) and has an inner threaded hole. The screw (70) extends through the central hole (512) of the external sleeve (51) and the central shaft (521) of the internal sleeve (52) and screws onto the inner threaded hole of the central rod (611) of the nozzle tube (60) to mount the nozzle tube (60) rotatably on the internal sleeve (52). The washers (614) are mounted respectively around the water inlets (612) to waterproof. The at least one board (62) is formed axially in the nozzle tube (60), and each board (62) is formed between each two water inlets (612) of the nozzle tube (60) to distinguish the water. The nozzle assemblies (63) are formed separately through the outer wall of the nozzle tube (60), and each nozzle assembly (63) corresponds to one water inlet (612) of the nozzle tube (60). The mounting ribs (64) are formed on the outer wall of the nozzle tube (60). The passing tubes (65) are formed radially through the nozzle tube (60).

The fastening device (67) is mounted securely in the first end of the nozzle tube (60), is mounted rotatably in the first bracket (10) of the main bracket and comprises a fastening tube (671), a fastener (672) and a C-clip (673). The fastening tube (671) is mounted securely in the first end of the nozzle tube (60), extends through the central hole (121) of the first bracket (10) and has an inner threaded hole and at least one recess (674). The recess (674) is formed in the fastening tube (671) and corresponds to and engages the board (62) of the nozzle tube (60). The fastener (672) extends through the central hole (121) of the first bracket (10) and is mounted securely in the fastening tube (671) and has threads and a leading pin (675). The threads screws to the inner threaded hole of the fastening tube (671). The leading pin (675) is formed on the fastener (672) to be used to clean the nozzle assemblies (63) of the nozzle tube (60). The C-clip (673) is mounted around the fastening tube (671) and abuts the partition (12) of the first bracket (10).

The adjustable spraying assembly (80) is mounted securely on the outer wall of the nozzle tube (60), corresponds to one of the nozzle assemblies (63) of the nozzle tube (60) and comprises multiple sealing bars (81), multiple switch devices (82) and a cover (83). The sealing bars (81) are mounted in one of the nozzle assemblies (63) and has multiple nozzles (811) formed through the sealing bars (81). The switch device (82) is mounted movably in the passing tube (65) of the nozzle tube (60) and has a control rod (821) and two lids (822, 824). The control rod (821) extends through the passing tube (65) of the nozzle tube (60) and has two ends and an annular groove (823). The annular groove (823) is formed radially in the control rod (821) and selectively aligns with the nozzles (811) of the sealing bar (81). The lids (822, 824) are mounted on the ends of the control rod (821) and abut against the passing tube (65) of the nozzle tube (60). The cover (83) is attached to the nozzle tube (60) and has an outside surface, an inside surface, multiple slots (831) and multiple mounting recesses (832). The slots (831) are formed through the cover (83) and correspond to the sealing bars (81) to allow the water spraying out from the nozzles (811) of the sealing bars (81). The mounting recesses (832) are formed in the inside surface of the cover (83) and correspond to and engage the mounting ribs (64) of the nozzle tube (60) to attach the cover (83) to the nozzle tube (60).

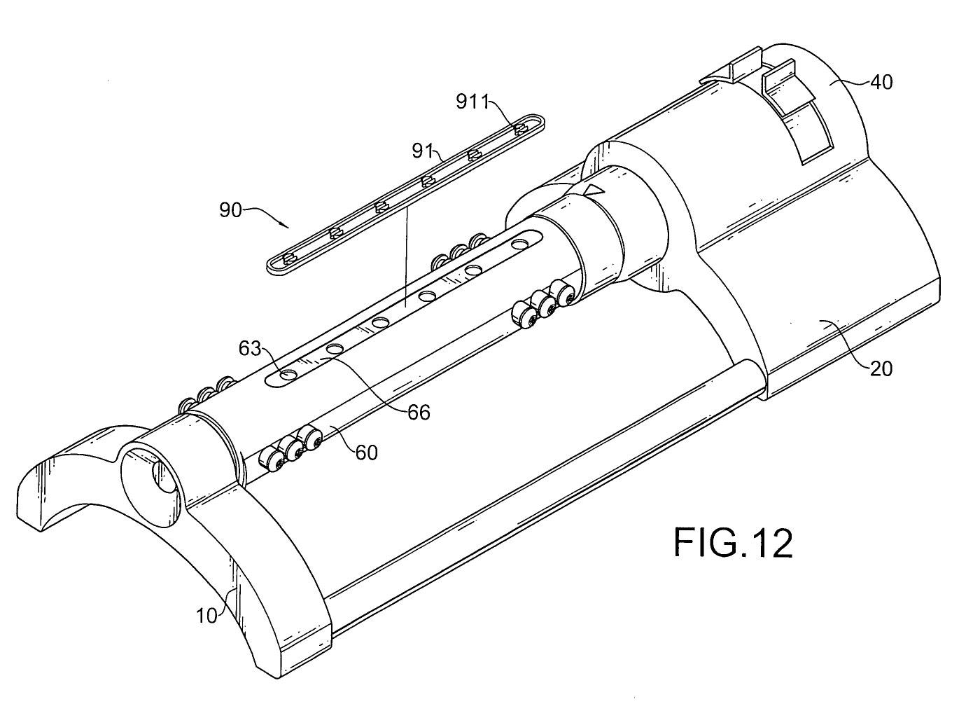

With further reference to FIG. 12, the spraying assembly (90) is attached to the nozzle tube (60) and has a sealing bar (91). The sealing bar (91) is mounted in one of the nozzle assemblies (63) of the nozzle tube (60) and has multiple nozzles (911) formed through the sealing bar (91).

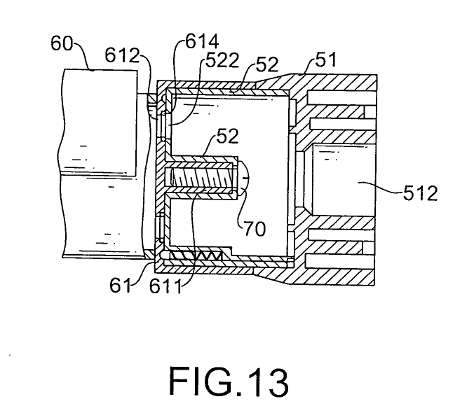

The water is provided through the water pipe into the rotating device (40). The water passes through the rotating device (40) and fills into the connecting device (50). The transmission rod (42) of the rotating device (40) rotates the connecting device (50) and the nozzle tube (60). With further reference to FIG. 13, the water passes through the central hole (512) of the external sleeve (51) and fills into the internal sleeve (52). The water passes through the water outlet (522) of the internal sleeve (52) and fills into the nozzle tube (60) through the water inlet (612) of the nozzle tube (60) aligning with the water outlet (522) of the internal sleeve (52). Then the water sprays out of the nozzle tube (60) through the nozzle assembly (63) or the spraying assembly (80, 90) corresponding to the water inlet (612) of the nozzle tube (60).

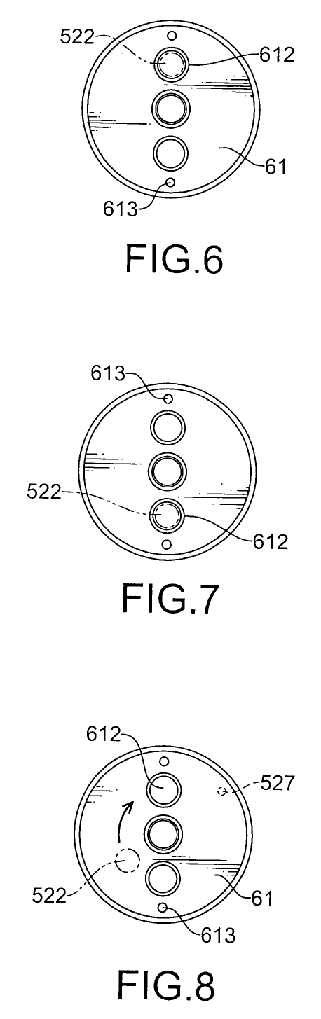

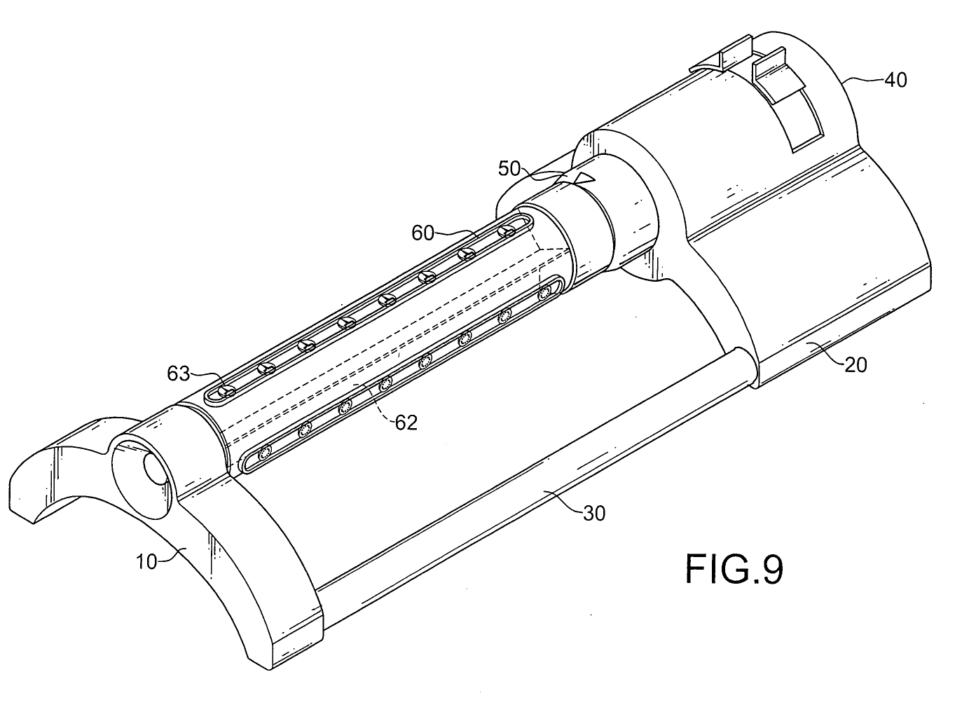

With further reference to FIGS. 6-8, the nozzle tube (60) is rotated relative to the connecting device (50) to change the water inlet (612) of the nozzle tube (60) aligning with the water outlet (522) of the internal sleeve (50). Then the corresponding nozzle assembly (63) or the corresponding spraying assembly (80, 90) is also changed. Therefore, the type of spray of the sprinkler of the present invention is changeable.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lawn sprinkler with changeable nozzles comprising:
a main bracket having
a first bracket; and
a second bracket being oppositely to the first bracket and having an inner side and an outer side;
a rotating device mounted in the second bracket and having a transmission rod extending through the inner side of the second bracket;
a connecting device attached to the transmission rod and having
external sleeve attached to the transmission rod of the rotating device and having
an inner wall;
an outer wall;
a first end;
a second end; and
a partition formed radially on the inner wall of the external sleeve and having a central hole mounted securely on the transmission rod; and
an internal sleeve mounted securely in the first side of the external sleeve and having
an opening end communicating with the central hole of the external sleeve;
a close end; and
a water outlet formed through the close end of the internal sleeve; and
an nozzle tube mounted in the main bracket, mounted rotatably on the internal sleeve and having
an outer wall;
a first end;
a second end;
a partition formed on and sealing the second end of the nozzle tube and having
an inside surface;
an outside surface abutting the close end of the internal sleeve; and
multiple water inlets formed separately through the partition of the nozzle tube and selectively aligning with the water outlet of the internal sleeve;
at least one board formed axially in the nozzle tube, and each board is formed between each two water inlets of the nozzle tube; and
multiple nozzle assemblies formed separately through the outer wall of the nozzle tube, and one of the nozzle assemblies corresponding to one of the water inlets of the nozzle tube.

2. The sprinkler as claimed in claim 1, wherein
the partition of the nozzle tube has two water inlets; and
the nozzle tube has one board formed axially between the two water inlets of the partition of the nozzle tube.

3. The sprinkler as claimed in claim 1, wherein
the partition of the nozzle tube has three water inlets; and
the nozzle tube has three board formed axially between each two water inlets of the partition of the nozzle tube.

4. The sprinkler as claimed in claim 1, wherein
the internal sleeve has
a positioning rib being hollow, formed on the close end of the internal sleeve, protruding from the opening end of the internal sleeve and having an opening end and a close end;
a spring mounted in the opening end of the positioning rib; and
a positioning pin mounted in and extending out of the opening end of the positioning rib and pressing against the spring in the positioning rib; and
the partition of the nozzle tube has multiple positioning detents formed in the outside surface of the partition of the nozzle tube, respectively corresponding to the water inlets of the partition of the nozzle tube and selectively engaging the positioning pin of the internal sleeve.

5. The sprinkler as claimed in claim 4, wherein
the external sleeve has an annular rib formed around the inner wall of the external sleeve near the first end of the external sleeve and having a gap; and
the close end of the positioning rib engaging with the gap of the annular rib of the external sleeve.

6. The sprinkler as claimed in claim 5, wherein the external sleeve has a mark formed on the outer wall of the external sleeve at a position opposite to the gap of the annular rib of the external sleeve.

7. The sprinkler as claimed in claim 6, wherein
the internal sleeve has a central shaft being hollow, formed on the close end of the internal sleeve, extending to the opening end of the internal sleeve and extending through the central hole of the external sleeve; and
the nozzle tube has
a central rod formed on the outside surface of the partition of the nozzle tube, extending through the central shaft of the internal sleeve and having an inner threaded hole; and
a screw extending through the central hole of the external sleeve and the central shaft of the internal sleeve and screwing onto the inner threaded hole of the central rod of the nozzle tube.

8. The sprinkler as claimed in claim 1, wherein
the nozzle tube has
multiple mounting ribs formed on the outer wall of the nozzle tube; and
multiple passing tubes formed radially through the nozzle tube; and
the sprinkler further comprises an adjustable spraying assembly mounted securely on the outer wall of the nozzle tube, corresponding to one of the nozzle assemblies of the nozzle tube and comprising
multiple sealing bars mounted in one of the nozzle assemblies and having multiple nozzles formed through the sealing bars;
multiple switch devices mounted movably in the passing tube of the nozzle tube and having
a control rod extending through the passing tube of the nozzle tube and having two ends and an annular groove formed radially in the control rod and selectively aligning with the nozzles of the sealing bar; and
two lids mounted on the ends of the control rod and abutting against the passing tube of the nozzle tube; and
a cover attached to the nozzle tube and having
an outside surface;
an inside surface;
multiple slots formed through the cover and corresponding to the sealing bars; and
multiple mounting recesses formed in the inside surface of the cover and corresponding to and engaging the mounting ribs of the nozzle tube.

9. The sprinkler as claimed in claim 1 further comprising a spraying assembly, wherein the spraying assembly is attached to the nozzle tube and has a sealing bar mounted in one of the nozzle assemblies of the nozzle tube and having multiple nozzles formed through the sealing bar.

10. The sprinkler as claimed in claim 1, wherein
the first bracket of the main bracket is arcuate and has
a bearing; and
a partition formed radially in the bearing and having a central hole;
the second bracket of the main bracket is arcuate and has
a bearing having an inner end and an outer end;
a partition formed on the inner end of the bearing and having a central hole;
a notch formed in the outer end of the bearing; and
two pins formed oppositely on the inner side of the second bracket, and each pin having
an outer wall; and
two slots formed longitudinally in the outer wall of the pin;
the main bracket further has two connecting rods mounted securely between the first and second brackets, and each connecting rod having
a first end attached to the first bracket;
a second end being an opening end and mounted around one of the pins of the second bracket; and
two protrusions formed on the second end of the connecting rod and engaging the slots of a corresponding pin of the second bracket;
the rotating device is mounted in the bearing of the second bracket and further has
a mounting bracket engaging the notch of the second bracket; and
a washer mounted around the transmission rod of the rotating device; and
the transmission rod of the rotating device extends through the central hole of the partition of the second bracket.

11. The sprinkler as claimed in claim 10, wherein
the transmission rod of the rotating device has
a distal end; and
multiple protrusions formed radially on the distal end of the transmission rod; and
the central hole of the partition of the external sleeve engages the protrusions on the transmission rod of the rotating device.

12. The sprinkler as claimed in claim 10, wherein the nozzle tube further comprises a fastening device mounted securely in the first end of the nozzle tube, mounted rotatably in the first bracket of the main bracket and comprising
a fastening tube mounted securely in the first end of the nozzle tube, extending through the central hole of the first bracket and having
an inner threaded hole; and
at least one recess formed in the fastening tube and corresponding to and engaging the board of the nozzle tube;
a fastener extending through the central hole of the first bracket and mounted securely in the fastening tube and having
threads screwing to the inner threaded hole of the fastening tube; and
a leading pin formed on the fastener; and
a C-clip mounted around the fastening tube and abutting the partition of the first bracket.
